(19) United States
(12) Patent Application Publication
(10) Pub. No.: US 2005/0197177 A1
(43) Pub. Date: Sep. 8, 2005

(54) A SYSTEM AND METHOD FOR SELECTIVE COLLECTION OF CONFIDENTIAL INFORMATION

(75) Inventor: James D. Charasika, Louisville, KY (US)

Correspondence Address: SNELL & WILMER;ONE ARIZONA CENTER, 400 EAST VAN BUREN, PHOENIX, AZ, 850040001, US

(73) Assignee: LOUISVILLE PRIMARY CARE, Louisville, KY (US)

(21) Appl. No.: 10/708,498

(22) Filed: Mar. 8, 2004

(51) Int. Cl. B42D 15/00

(52) U.S. Cl. 462/28

(57) ABSTRACT

The present invention relates to a system and method for selective collection of confidential information comprising a plurality of overlapping stacked complete information collection sheets, which are overlying a reproduction enabling media, which is overlying a record data sheet. Each of the plurality of complete information collection sheets includes a select information portion in communication with the reproduction enabling media, and a portion for collecting nonselective information not in communication with the reproduction enabling media. Thus, only the information provided with respect to the select information of each of the plurality of complete collection sheets is reproduced on the record data sheet for later review. The select information is correlated to a unique information identifier when reproduced on the record data sheet. When entered into a data storage database, the unique identifier may be used to reference or recall any portion of the complete information provided.

### FIELD OF INVENTION

The present invention generally relates to a system and method for selective collection of information, and more particularly, a system and method for selective collection of confidential information.

### BACKGROUND OF INVENTION

When a person seeks medical treatment from a specific physician, and the physician agrees to treat the person, the person becomes a patient of the physician, and a physician-patient relationship results. The physician and the patient then work together to ensure that the patient receives the best medical care for the patient's specific ailment. Paramount to ensuring proper medical treatment is the ability of the physician to obtain accurate, truthful and complete patient medical history. Obtaining such accurate medical history is critical to the physician's ability to diagnose the patient's illness properly and prescribe the proper medical treatment.

Much of the medical history is supplied to the physician by the patient. The physician, therefore, often must rely on the veracity of the information provided by the patient when organizing a patient treatment plan. Contravening the physician's ability to obtain accurate medical history from the patient, however, is the patient's concern that should he/she reveal deeply personal information, even that which may be relevant to the patient's treatment, the information will not be kept secret. Consequently, to provide assurance that a patient's personal information is kept secret, the medical profession and the U.S. Congress have gone to great lengths to impose a measure of “confidentiality” on the physician-patient relationship, (called the “physician-patient confidentiality”). In short, the physician-patient confidentiality assures a patient that information communicated to a patient's treating physician concerning the patient's medical case, is kept secret.

One effort to preserve physician-patient confidentiality is the United States Health Insurance Portability and Accountability Act of 1996 (“HIPPA”). Congress enacted HIPPA to strengthen the protections given by the physician-patient confidential relationship. In part, HIPPA provides protection for millions of workers and their families who have pre-existing medical conditions or who might suffer discrimination in health coverage based on a factor that relates to an individual's health. Title II, subtitle F, sections 261-264 of HIPPA require certain measures to be taken by medical care providers to secure medical information while in the provider's custody and during transit. Although the specific measures to be taken are not specifically described in HIPPA, the HIPPA legislation makes it increasingly clear that the legislature considers medical information inherently intimate and personal, and precisely the sort of information intended for privacy protection.

It should be noted that the confidentiality owing to the physician-patient relationship belongs to the patient, and not to the physician. Thus, only the patient may freely divulge the patient's medical information. On the other hand, the physician may only divulge the information with the patient's permission, or if there is some legal justification or excuse. Disclosure by the physician of the patient's medical information without proper cause is actionable, and may subject the physician to a charge of, inter alia, invasion of privacy, infliction of emotional distress, breach of patient confidentiality and/or the unauthorized disclosure of patient medical information. Consequently, medical care providers are constantly trying to invent new ways to conform to the HIPPA requirements and ensure that a patient's medical history is kept confidential.

Conventional security methods for ensuring patient confidentiality focus on maintaining confidentiality upon receipt of the medical information from the patient. More particularly, the conventional confidentiality security methods are designed to ensure that the information is secreted after the patient communicates his medical information, during maintenance of the patient information while being stored at the treating medical facility, and/or when reporting or translating the results of any medical or diagnostic procedures performed on the patient.

For example, U.S. Pat. No. 6,463,417 issued Oct. 8, 2002, to Schoenberg discloses a method and system for distributing health information after the information is received that permits the patient to construct a list of access codes relative to the security level to be maintained for a particular malady. The patient's medical records are divided into a hierarchy of categories corresponding to the access codes. Each category includes a level of privacy associated therewith, which is greater than the previous category level. The lowest hierarchical category level may include, for example, information such as blood type and allergies, while the highest level may include, for example, life threatening diseases, genetically originating diseases, and/or a patient's HIV status. By assigning the access codes, the patient is permitted to control how much access to the patient's medical records a particular medical care provider is to have.

The Schoenberg system, however, is often too complicated for patients, since the patient must have a clear understanding of the operation of the access codes and the hierarchical categories. That is, a patient who is the least bit confused by the Schoenberg system is likely to assign an errant access code level to a medical condition the patient would like to keep confidential from all but the treating physician. For example, a confused HIV patient may mistakenly assign the lowest access code to his HIV status, thereby providing his HIV status the lowest possible confidentiality protection afforded by the medical care provider. In addition, the Schoenberg system is time consuming in that time is required for determining and assigning the proper access codes. Thus, Schoenberg is unsuitable for use in a patient receiving or intake area concerned about speeding up the patient's treatment experience, since long lines will be created by the delay caused by the code assigning process.

U.S. Pat. No. 4,815,768 issued Mar. 28, 1989, to Applebaum, et al., discloses a method for keeping medical test results confidential. The Applebaum invention provides an easily carried, tamper resistant card to be carried by the patient for the disclosure of confidential information. The card is an elongated card having a center portion and opposite, separate extremity wing portions, which is supplied to the testing physician. The opposite wing portions may include some indicator of alternative test results (e.g., positive vs. negative results). The center section of the card includes encoded patient information. By removal of either of the extremity wings, the patient's physician can indicate the patient's medical results corresponding to the remaining wing. The removal of the appropriate extremity wing thus leaves a card which may be wallet sized, which is highly resistant to alteration and forgery, and which indicates a test result known only to the patient and the physician's office.

Although the Applebaum system may be suitable for communicating a medical condition to a patient, or for permitting the patient to carry record of a medical condition, the system is of little utility for ensuring confidential collection of information from the patient at the commencement of the medical visit at the patient reception area. Thus, the Applebaum system is unsuitable for use in confidentially collecting patient information during patient intake.

Another system used for ensuring patient confidentiality is disclosed in U.S. Pat. No. 6,397,224, issued May 28, 2002, to Zubeldia. The Zubeldia patent teaches a system for anonymously linking a plurality of data records, each data record comprising a plurality of elements for identifying an associated individual. The system of Zubeldia comprises a first identity reference module for encoding a first encoded identity reference from a first subset of identifying elements of a data record, a second identity reference module for encoding a second identity reference from a second subset of the identity elements of the data record, and an anonymization code assignment module configured to assign to the first and second identity references an identical anonymization code for anonymously representing the individual associated with the data record. The anonymization module includes a lookup table for use in determining each of the first and second identity codes. The anonymization module compares the first and second identity references to the data contained in the lookup table. If a match exists, then the patient identity may be anonymously correlated to the patient data record where necessary.

The Zubeldia invention is useful for linking anonymized patient data records, however, the system is more complicated than what is generally needed for the operation of typical independent medical care provider locations which maintain the medical records on site. That is, the system requires the use of sets and subsets of data for the anonymization process, which are superfluous, since most small independent locations of medical providers do not need the plurality of security levels or identity references to properly maintain patient confidentiality. For example, in some instances, where a medical facility wishes to only collect preliminary information for physician use (e.g., reason for visit, nature of injuries origin, and whether a patient is a new patient or one requiring a change in patient identifying information), the use of a plurality of security levels may be unnecessary for use in keeping the information confidential.

In addition to being overly complicated, as noted, conventional methods for keeping patient information confidential retard the patient intake screening process. One major complaint amongst patients is the length of time spent waiting in the medical facility intake room to be seen by a physician. In a typical patient visit, a patient checks in with the office receptionist and must wait to be called to complete the proper medical care paperwork. Where a system is able to prescreen the patients prior to them seeing a physician, the physician may be provided advance notice of the patient's complaints and prepare for the patient's visit accordingly, thereby speeding up the patient's medical care experience.

The conventional methods of protecting patient confidentiality pay little or no heed to this aspect of the patient visit, and therefore a more efficient method of prescreening a patient during the patient intake process is needed. By “prescreening” what may be meant is that the patient's basic information (e.g., name, address, insurance number, reason for visit, and any other minimal information related to the patient visit) may be collected, confidentially, anonymized, separated, analyzed, categorized, or minimally processed prior to the patient receiving medical attention.

Thus, a method and system for collection of confidential information especially during patient intake is needed which confidentially collects patient information at the commencement of the patient visit, which includes minimal cost effective components for operation by independent medical care locations, and is easy for the patient to operate to prevent errant assignment of confidentiality security levels.

### SUMMARY OF INVENTION

The present invention relates to a system and method for confidential collection of information. The invention is especially useful in the patient intake process, where a patient visit commences at a medical facility. Although the present patient invention is described with respect to collection of confidential information in a medical setting (e.g., patient medical history), the invention is not so limited. That is, it is contemplated that the invention may be used to collect confidential information included in any set of data. More particularly, the invention is useful for any environment wherein at least a portion of the data collected is to be kept confidential.

In one aspect, the invention facilitates the patient intake process by providing a system and method permitting multiple patients to disclose confidential medical information using the same collection device. The invention is useful in the patient intake process in that multiple patients use the collection device to present preliminary intake information to the health care provider which may be used to enroll a patient in a providers patient tracking system or to update a patient's existing records. In that regard, multiple patients may use the data collection device of the present invention to disclose medical and non-medical information which enables the provider to swiftly record a patient's medical needs, while keeping secreted the information protected by the physician patient confidentiality. The preliminary intake information may also be provided to the treating physician to enable the physician to prepare for patient treatment in advance. In either case, the invention speeds up the patient treatment experience by speeding up the patient intake process.

The invention permits a patient to present non-confidential information and confidential information (called “complete patient information,” herein), while ensuring that the confidential information will be only minimally compromised. The non-confidential information may consist of, for example, a patient's name, address, phone number and/or time and date of medical visit and/or the like. On the other hand, the confidential patient information may include, for example, insurance policy information, and reason for seeking the medical care, or any other information related to patient treatment. It should be noted that the definitions of non-confidential and confidential as used herein are exemplary definitions not intended to limit the invention. Those skilled in the art may choose equally suitable definitions which are contemplated for use herein.

As noted, although multiple patients provide complete patient information using the same collection device, the invention distills the complete patient information, by reproducing the non-confidential information in a single non-confidential data storage location for later comparison and review. The non-confidential information may be stored correlative to a distinct patient identifier. The non-confidential information and the distinct patient identifier may be recorded in the single non-confidential data storage location in real-time as the patient provides the information. The single non-confidential data storage location may then be used to track the medical facility patient traffic, recall a patient visit, or the like. In addition, although the same device is used by multiple patients, no single patient is made aware of the non-confidential information of the other patients.

As previously stated, the non-confidential portion of the complete patient information may be correlated to a distinct patient identifier. The patient identifier, may be used to track a specific patient's information. As the patient provides his non-confidential information, the non-confidential information is simultaneously correlated to the unique identifier and simultaneously recorded/reproduced at the single non-confidential data storage location apart from confidential information. In this way, the patient non-confidential information may be viewed without compromising the patient's confidential information.

The distinct identifier may also be correlated to the complete patient information, or a portion thereof, when processing. As such, the patient complete information may be retrieved by obtaining the identifier from the single non-confidential data storage location, and correlating the identifier to the appropriate patient confidential information corresponding to the identifier.

As can be seen, the single location including non-confidential patient information may then constitute a record of the patients visiting a medical facility over a particular time period. Such information may be useful, for example, for later recounting the list of patients who have visited on a particular day and time, a particular patient visit, tracking the number of patients seen during a particular time frame, or the like.

In one exemplary embodiment, the system and method according to the invention comprises a data collection device including one or more confidential data recording sheets (e.g., complete patient information sheets) for recording complete patient information. Each complete patient information sheet may include a distinct patient identifier (e.g., patient number) for use with correlating anonymized or separated patient information with the confidential patient information. The confidential data recording sheets are arranged in overlapping layered position, such that the entirety of the uppermost sheet is accessible at any one time, while only portions of the underlying sheets are visible. When two or more confidential recording sheets are collectively viewed from rear, it can be seen that the topmost portion of the underlying recording sheet begins where the portion of the overlying sheet for collection of non-confidential information ends. The sheets are additionally arranged so that a topmost portion of each successive underlying sheet, used to collecting non-confidential patient information, is positioned below the portion of the next overlying sheet which is used for collecting the non-confidential information.

Underneath the layers of confidential data recording sheets (e.g., plurality of complete patient information sheets) is a non-confidential data storage sheet for recording the non-confidential information. A reproduction enabling media is interposed between the confidential data recording sheets and the data storage sheet to facilitate the recording of the patient non-confidential information separately from the confidential information. In particular, as noted, the topmost portion of each underlying sheet begins where the non-confidential data collection portion of the preceding sheet ends. The layered sheets are arranged such that the underside of the non-confidential data collection portion of the uppermost sheet is directly contacting the reproduction enabling media, which is contacting the non-confidential information data storage sheet, so that the media reproduction may enable the recording of the patient non-confidential information at the single non-confidential information data storage location. The remaining bottommost portion of the uppermost collection sheet beginning after the non-confidential data collection portion of the uppermost sheet, has a substantial portion of the underlying sheet interposed between the bottommost portion of the topmost sheet and the non-confidential information data storage sheet. In this arrangement, only the underside of the non-confidential information portion of the topmost sheet is exposed directly to the reproduction enabling media. Since only the portion of the topmost sheet for collecting the non-confidential information is exposed directly to the reproduction enabling media, then only the topmost sheet non-confidential portion of the complete patient information is reproduced on the non-confidential data storage sheet. Further, as a patient provides both the confidential and non-confidential information, only the non-confidential information is reproduced on the non-confidential data storage sheet. This, in turn, creates a complete non-confidential record of the patients visiting a medical facility over a given period of time.

### BRIEF DESCRIPTION OF DRAWINGS

A more complete understanding of the present invention may be derived by referring to the detailed description and claims when considered in connection with the Figures, where like reference numbers refer to similar elements throughout the Figures, and:

FIG. 1 illustrates an exemplary confidential information collection system in accordance with an exemplary embodiment of the present invention;

FIG. 2 illustrates an exemplary complete patient information sheet in accordance with an exemplary embodiment of the present invention;

FIG. 3 illustrates an exemplary confidential patient information collection device in accordance with an exemplary embodiment of the present invention;

FIG. 4 illustrates an exemplary reproduction enabling media in accordance with an exemplary embodiment of the present invention;

FIG. 5 illustrates an exemplary non-confidential information record sheet in accordance with an exemplary embodiment of the present invention;

FIG. 6 depicts an exemplary flow chart of an exemplary method of operation in accordance with an exemplary embodiment of the present invention;

FIG. 7 is an illustration of an exemplary collection device depicting the topmost one of a plurality of complete patient information sheets in raised position prior to removal in accordance with an exemplary embodiment of the present invention;

FIG. 8 is an illustration of an exemplary collection device depicting the topmost one of a plurality of complete patient information sheets completely removed to reveal the reproduction enabling media and the remaining underlying complete patient information sheets in accordance with an exemplary embodiment of the present invention; and

FIG. 8 is an illustration of an exemplary record sheet depicting the reproduction and/or recording of patient non-confidential information in a single location separate from the complete patient information data, and wherein the patient non-confidential information is shown reproduced on the record sheet, in accordance with an exemplary embodiment of the present invention.

### DETAILED DESCRIPTION

The present invention relates to a system for collecting confidential information and method for using the same. Specifically, the present invention relates to a system which enables a service or product provider to record both non-confidential information (e.g., not related to patient care) and confidential information (e.g., related to patient care) while simultaneously, recording/reproducing non-confidential information in a location separate from the confidential information. For example, a medical provider may collect the name, date and time of visit for a patient while also collecting the nature of the patient care needed. In this instance, non-confidential information (e.g., name, date and time of visit) may be reproduced in a separate location from the complete patient information. In one exemplary embodiment of the present invention the patient's non-confidential information (e.g., name, date and time of visit, etc.) may be recorded separately from the complete patient information.

It should be noted that although the present invention is described herein with reference to collecting confidential patient information in a medical provider environment, the invention is not so limited. The invention contemplates the collection of any information in any environment, although the invention is especially useful in any environment requiring confidentiality. For example, many service and credit card providers may use the invention to collect information regarding their customers. In this instance, the content of the information collected by the invention may change depending on the service or product requested. Thus, the invention is not limited to collection of patient information, and more importantly, the invention is not in any way limited by the nature of the information collected. The invention is useful in any environment wherein one portion of the information collected is to be recorded or reproduced separately from another portion of the information where such reproduction of information is done in real-time.

The various embodiments disclosed herein may be described in terms of various functional components and various processing steps and stages. It should be appreciated that such functional components may be realized by any number of hardware or structural components configured to perform the specified functions. For example, the various embodiments may employ integrated components comprised of various electrical devices (e.g., resistors, transistors, capacitors, diodes and the like), whose values may be suitably configured for various intended purposes. In addition, the various embodiments involving data manipulation may be practiced in any integrated circuit application configured to anonymize data or separate data intended to be kept confidential from a data source. Such general applications that may be appreciated by those skilled in the art in light of the present disclosure are not described in detail herein.

For purposes of illustration only, the various exemplary embodiments will be described herein in connection with separating confidential and non-confidential patient medical information or anonymizing (i.e., making anonymous) the complete patient information. It should also be appreciated that the particular implementations shown and described herein are illustrative examples of the various embodiments and are not intended to otherwise limit the scope of the disclosure in any way. Indeed, for the sake of brevity, conventional electronics, transistors, differential amplifiers, data storage and manipulation and other functional aspects of the various embodiments (and components of the individual operating components of the various embodiments) may not be described in detail herein. Further still, it should be noted that while various components may be suitably coupled or connected to other components within the exemplary elements described herein, such connections and couplings can be realized by direct connection between components, or by connection through other components and devices located there between. Moreover, no item or component is essential to the practice of the invention unless the element is specifically described as “essential” or “critical.”

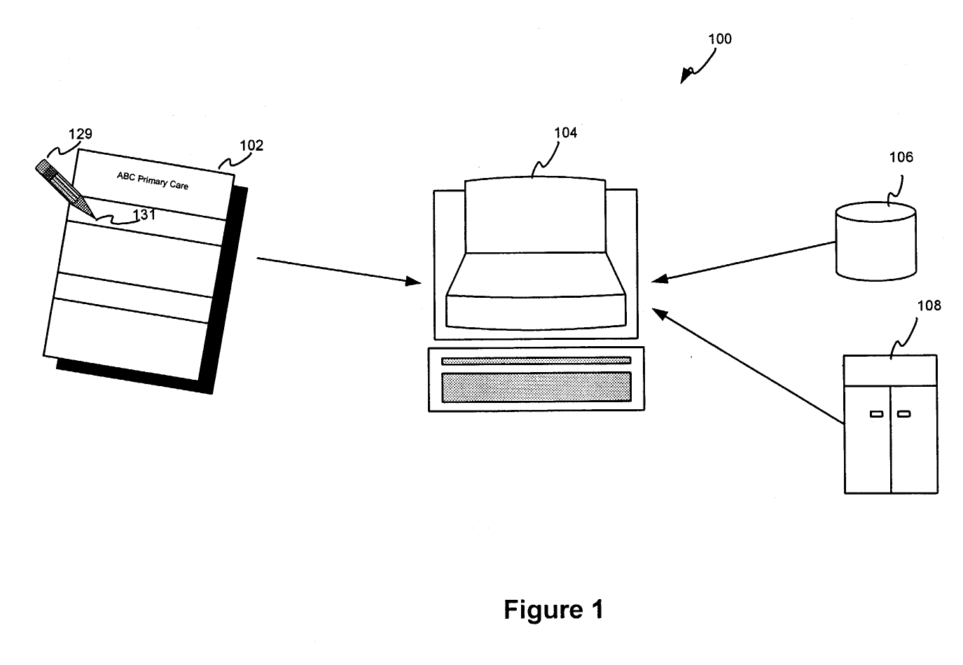

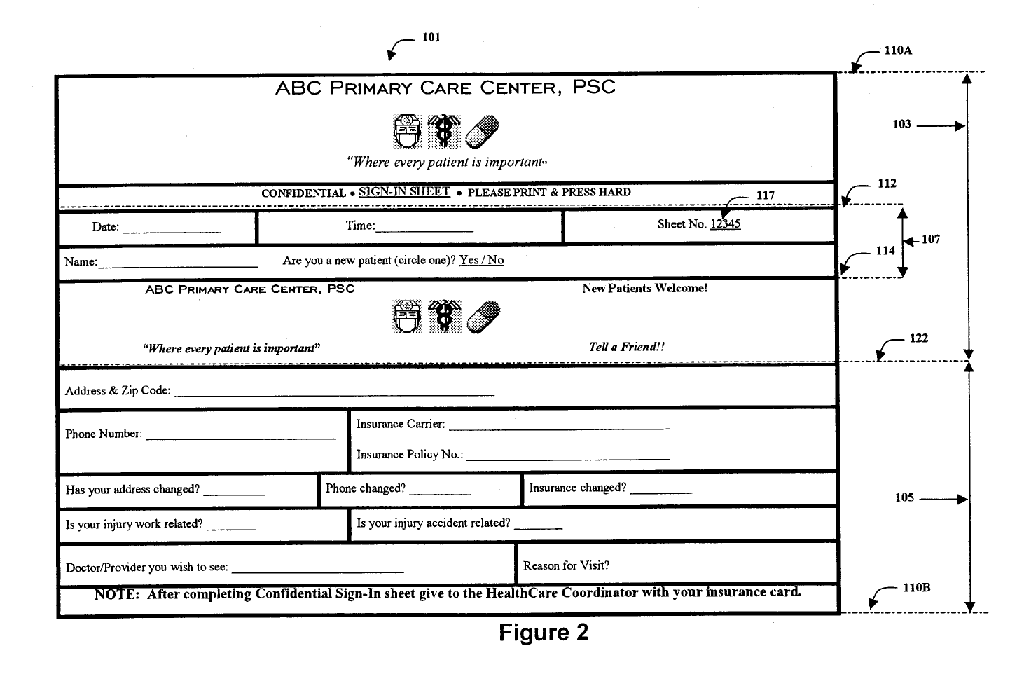

FIG. 1 illustrates an exemplary confidential information collection system 100 in accordance with the present invention, wherein exemplary components for use in confidentially collecting information in accordance with the invention are depicted. In general, system 100 includes, a complete patient information collection device 102 and a user computer system 104 which includes a secure memory database 106 and a central processing unit 108. As described more fully below, the complete patient information collection device 102 is used to collect complete patient information and to reproduce select portions of the information in a separate remote location. In particular, collection device 102 is configured to reproduce a record of the non-confidential information simultaneously with the non-confidential information being provided. The complete patient information is provided to the computer system 104, and the processor 108 correlates the complete patient information to a unique distinct patient number (e.g., sheet number) corresponding to a complete patient confidential sheet 101 (shown in FIG. 2). The unique patient number and the complete patient information are stored in database 106, such that the complete patient information may be retrieved by reference to the unique patient number.

Secure memory database 106 may be any suitable elementary file system such as that defined by ISO/IEC 7816-4 or any other elementary file system allowing a lookup of data to be interpreted by correlating software application used by the processor 108 to relate the complete patient information to the unique patient identifier. Database 106 may be any type of database, such as relational, hierarchical, object-oriented, and/or the like. Common database products that may be used to implement the databases include DB2 by IBM (White Plains, N.Y.), any of the database products available from Oracle Corporation (Redwood Shores, Calif.), Microsoft Access or MSSQL by Microsoft Corporation (Redmond, Wash.), or any other database product. Database 2108 may be organized in any suitable manner, including as data tables or lookup tables. Association (e.g., correlation) of certain data may be accomplished through any data association technique known and practiced in the art. For example, the association may be accomplished either manually or automatically. The processor 108 may use any automatic association techniques which may include, for example, a database search, a database merge, GREP, AGREP, SQL, and/or the like. The association step may be accomplished by a database merge function, for example, using a “key field” associated with each complete patient record. A “key field” partitions the database according to the high-level class of objects defined by the key field. For example, a certain class may be designated as a key field in both the first data table and the second data table, and the two data tables may then be merged on the basis of the class data in the key field. In this embodiment, the data corresponding to the key field in each of the merged data tables is preferably the same. However, data tables having similar, though not identical, data in the key fields may also be merged by using AGREP, for example. In that regard, processor 108 may be any suitable conventional computer processor able to correlate or associate data using an association software or technique and a database, such as, those noted above. To that end, computer system 104 may be any conventional system including the database 106 and processor 108, which is capable of providing instructions for data manipulation.

FIG. 2 illustrates an exemplary complete patient information sheet 101 in accordance with the present invention. The complete patient information sheet 101 may be comprised of any media suitable for use with a conventional writing instrument, such as, for example, a pen, marker, pencil, crayon, or the like. In one exemplary embodiment, sheet 101 may be comprised of, for example, conventional paper capable of receiving marking and/or impressions made by the conventional writing instrument. The sheet 101 may include instructions for indicating to the patient where to provide both the patient's confidential and non-confidential information.

With respect to exemplary sheet 101, the instructions are a request for the patient to provide information about the patient and/or the patient's treatment needs. In one exemplary embodiment, non-confidential information is provided in a separate location on sheet 101 than confidential information, although the non-confidential information may be provided interspersed with the confidential information. Preferably, the confidential and non-confidential information are grouped separately, such that a first portion of the complete patient information sheet 101, includes only non-confidential information and an second portion of the sheet 101 includes only confidential information. Most preferably, the non-confidential information is grouped separately from the confidential information and the portion of sheet 101 for providing the non-confidential information is located in the topmost half of sheet 101. The portion of sheet 101 for collecting the non-confidential information from the patient is called the “non-confidential information section” 107 herein, as is described more fully below.

The width of the sheet 101 measured from right to left may be substantially similar to any conventional letter size sheet, although any width suitable for the purposes described herein is contemplated. The length of the sheet 101 measured from top to bottom may be any length suitable for accommodating multiple complete patient information sheets in an overlapping manner on a single collection device, as described more fully below. The length of sheet 101 may be selected as desired for collecting the pertinent patient information.

As can be seen, sheet 101 includes a topmost portion 103 given by the portion of sheet 101 in between dotted lines 110A and 122. The bottommost portion 105 of sheet 101 is given by the portion of sheet 101 in between dotted lines 122 and 110B. The portion of the sheet 101 in between dotted lines 112 and 114 is the non-confidential information section 107 of sheet 101, which is the portion of the sheet 101 used to collect the non-confidential patient information. The bottommost portion 105 is used to collect the confidential patient information.

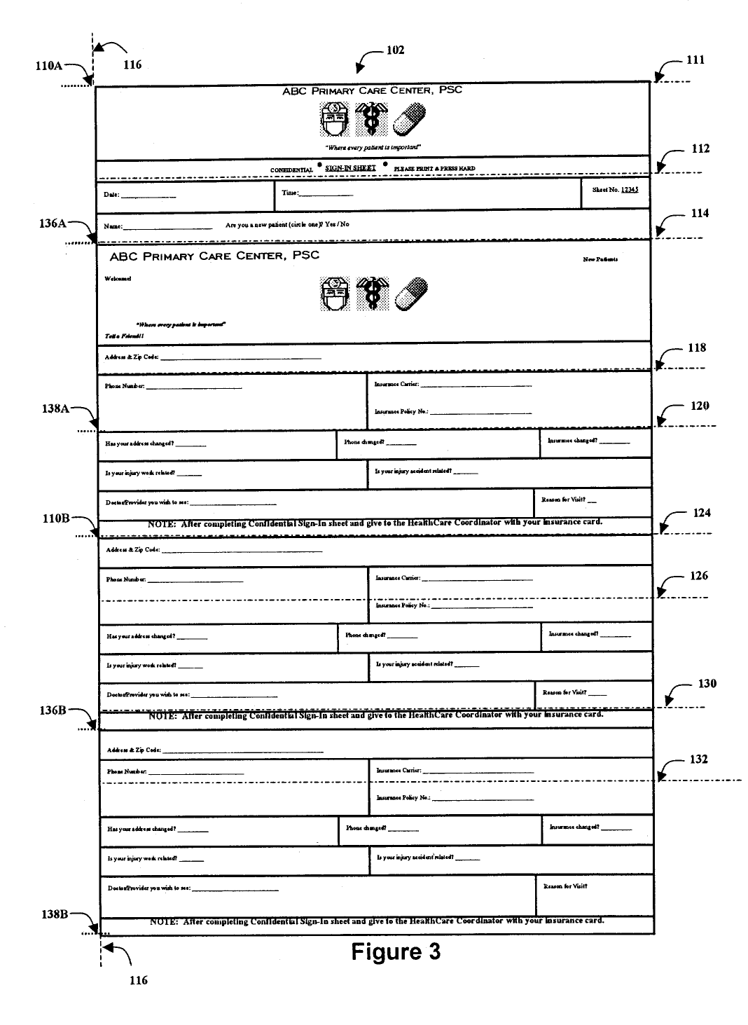

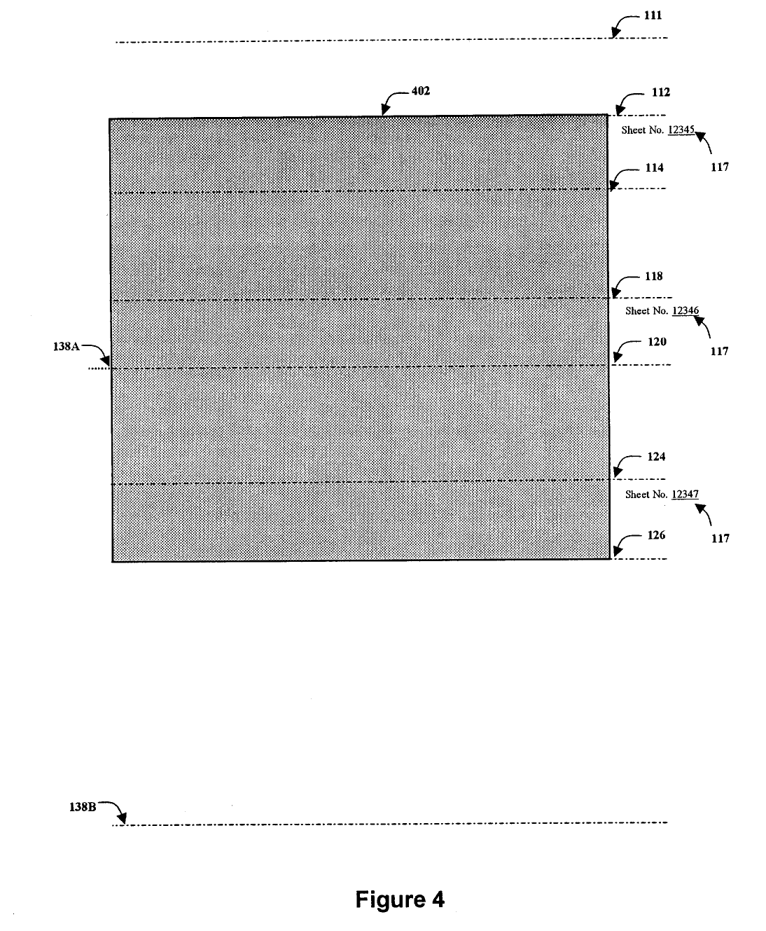

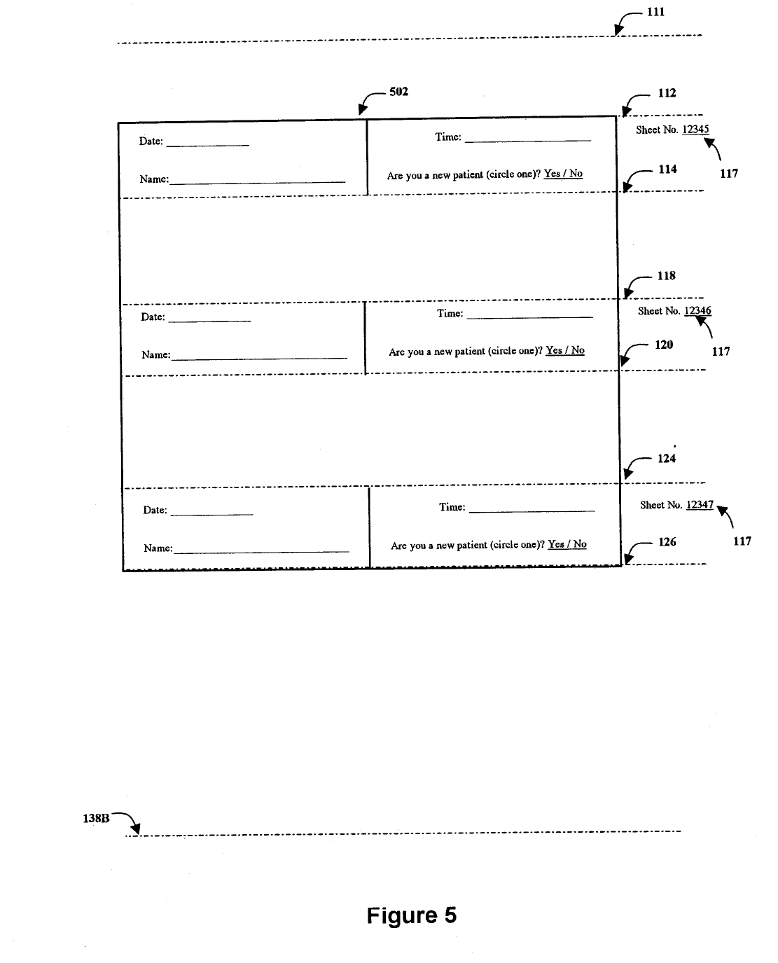

FIG. 3 illustrates a confidential patient information collection device 102 in accordance with the invention. Collection device 102 includes a plurality of complete patient information sheets arranged in overlapping fashion, a reproduction enabling media (shown in FIG. 4) underlying the plurality of patient information sheets and a non-confidential information record sheet (shown in FIG. 5) underlying the reproduction enabling media. The uppermost overlying sheet, called sheet 101, herein, has its top edge at dotted line 110A and its bottom edge at dotted line 110B. A second complete patient information sheet is underlying sheet 101, wherein the second sheet begins at dotted line 136A and ends at dotted line 136B. A third complete patient information sheet is underlying sheet 101 and the second complete information sheet, wherein the third sheet begins at dotted line 138A and ends at dotted line 138B.

It should be noted that although collection device 102 is depicted with three complete patient information sheets, the invention is not so limited. For example, an additional complete patient information sheet may be included which may begin at dotted line 132. Further, the length of the multiple complete patient information sheets may be adjusted to accommodate any number of suitable sheets. For example, the information collected on the sheets may be compressed and the length of the sheets shortened to accommodate any number of sheets as desired on or in collection device 102.

As noted, sheet 101 includes a non-confidential collection portion 107 in between dotted lines 112 and 114. In addition, the plurality of complete patient information sheets are arranged in an overlapping manner. Sheet 101 may be positioned at the topmost portion of collection device 102. The second complete patient sheet maybe underlying sheet 101 with the top of the second sheet beginning at dotted line 114, and the end of the second sheet at dotted line 136B. Similarly, the third complete patient information sheet is underlying the second sheet with the top of the third sheet beginning at dotted line 120 which is the bottom edge of the non-confidential information collection portion of the second sheet), and the end of the third sheet at dotted line 138B. When this arrangement is viewed from the rear of the plurality of complete patient information sheets, the plurality of sheets are overlapping with a topmost portion of each of the sheets including the non-confidential information collection portion of overlying sheet, exposed to the reproduction enabling media, as described more fully below.

Depicted in FIG. 4 is an exemplary reproduction enabling media 402, which may be positioned underlying the plurality of complete patient sheets described above. The reproduction media 402 may be substantially immobile with respect to the plurality of complex patient information sheets. The reproduction enabling media 402 may be any media capable of transferring an impression made on a first side of the media 402 to a surface positioned in direct tactile communication with a second side of media 402, where the first side of media 402 may be the front side of the media 402 and the second side may be the underside of media 402. In one exemplary embodiment, the media 402 may enable impressions or indentations on the front side of the media 402 to be copied, mimicked, reproduced, and/or duplicated substantially identically on any surface in contact with the underside of the media 402 directly behind the portion where the impression is made. In another exemplary embodiment, the media 402 may include a material or chemical composition in the media 402 or on the media 402 underside, which permits the impressions made on the media front side to be reproduced on the underlying surface. The impression may be formed on the underlying surface by transfer of the material or chemical composition or the like, to the surface as dictated by the nature of the writing instrument and the media 402 used, such that the shape and order of the material composition matches the shape and order of the impression made on the front side of the media. In that regard, media 402 may be, for example, a convention in carbon copy paper, a no-carbon copypaper, transfer ink coating, a waxless carbon copy paper, although any suitable conventional pressure marking copy medium for transferring impressions in the manner indicated is contemplated. The functionality and operation of such media is well understood in the art. As such, a description of the media 402 will not be repeated herein for brevity. Suitable media 402 which may be used with the present invention are disclosed in U.S. Pat. No. 4,150,174 entitled “Pressure Marking Materials”, issued Apr. 17, 1979, to Lawton, U.S. Pat. No. 4,653,660 entitled “Low cost transfer ink coating”, issued Oct. 11, 1977, to Horwitz, et al., U.S. Pat. No. 4,593,935 entitled “Conditional self-copying stationery”, issued Jun. 10, 1986, to Kearns, and the like.

The length and width of the media 402 may be such that the underside of the non-confidential information collection section of each sheet is in direct communication with the media 402. For example, the topmost portion of the media 402 may be positioned in at least substantially the same location as the beginning portion of the non-confidential information collection section 107 of sheet 101 (e.g., dotted line 112). The bottommost portion of the media 402 may be positioned in at least substantially the same location as the bottom edge of the non-confidential information section of the bottommost complete patient information sheet. For example, where the collection device 102 includes three sheets as shown in FIG. 3, the bottommost portion of the media 402 may be at least substantially aligned with the bottom edge of the non-confidential information section of the third underlying sheet (e.g., dotted line 126). It should be noted, however, that the length and width, and indeed the shape, of the media 402 may be chosen in accordance with the collection requirements. For example, the media may be substantially the same length and width as the collection device 102, slightly smaller than collection device 102, or may be irregular shaped so long as the underside of those portions of the complete patient information sheet to be reproduced are permitted to contact the topside of the media 402.

As noted, media 402 enables reproduction of impressions made on the media 402 front side by transferring a substantially identical reproduction of the impression to a surface in direct communication with the media 402 underside. For brevity and to aid in understanding the invention, the transfer of the impression made on the non-confidential information section of a complete patient information sheet to an underlying reproduction or recording media is described herein with respect to sheet 101. The description of the transfer is understood to apply equally to all subsequent underlying sheets included in collection device 102.

In accordance with the invention, the underside of media 402 may be placed in direct communication with a recording media, for receiving the substantially identical reproduction. As noted, the reproduction media 402 is configured to reproduce, in a single location, a reproduction of predetermined portions of the information provided on the complete patient information sheet (e.g., sheet 101). As previously described, the underside of the non-confidential information collection section 107 of each sheet is in direct communication with the reproduction media 402. Thus, when an impression is made on the frontside of media 402 at the non-confidential information collection section 107 of sheet 101, a substantially identical reproduction of the impression is made on the portion of the recording sheet underlying the portion of the reproduction media 402 where the impression is made.

FIG. 5 illustrates an exemplary recording media (non-confidential information record sheet 502) for use in the invention. Non-confidential information record sheet 502 may be any media capable of receiving an impression from media 402. It is preferable that the non-confidential information record sheet 502 be portable. In addition, in one exemplary embodiment, the non-confidential information record sheet 502 may be comprised of similar structure and composition as the complete patient information sheets, described above.

Sheet 502 may be positioned underlying the reproduction media 402, which underlies the plurality of complete patient information sheets. In addition, sheet 502 may be any length and width enabling the record sheet 502 to receive a reproduced impression from reproduction media 402. Preferably, the length, width and shape of record sheet 502 is chosen such that those areas of the complete patient sheet which are to be reproduced, and which are positioned in direct communication with media 402, may be reproduced on record sheet 502. More preferably, the record sheet 502 is chosen to be substantially the same length, width and shape of the media 402 as shown in FIG. 4. Most preferably, the length, width and shape of the record sheet 502 is chosen to enable recording of the information provided at the non-confidential information section (e.g., section 107) of each of the plurality of complete patient information collection sheets (e.g., sheet 101), as described more fully below.

As noted, the collection device 102 includes a plurality of overlapping collection sheets with a portion of each sheet in direct communication with reproduction media 402. Reproduction media 402 may be overlying and in direct communication with record sheet 502. The plurality of collection sheets, the reproduction media 402 and the record sheet 502 may be variously attached one to another on at least on one edge, such that the collection sheets, media 402 and record sheet 502 are substantially fixed with relation to each other. For example, the collection sheets, media 402, and/or record sheet 502 may be attached at the edge of device 102 indicated by dotted line 116 (see FIG. 3). The edge of the collection sheets along dotted line 116 may be removably attached to enable individual removal of each sheet. In that regard, sheets 102 may be attached using any means for fastening or attaching which permit easy detachment. Such suitable means for fastening may include, glue or adhesive, perforations, spiral or ringed binding, clips, staples, tape, fly fasteners, rivets or the like.

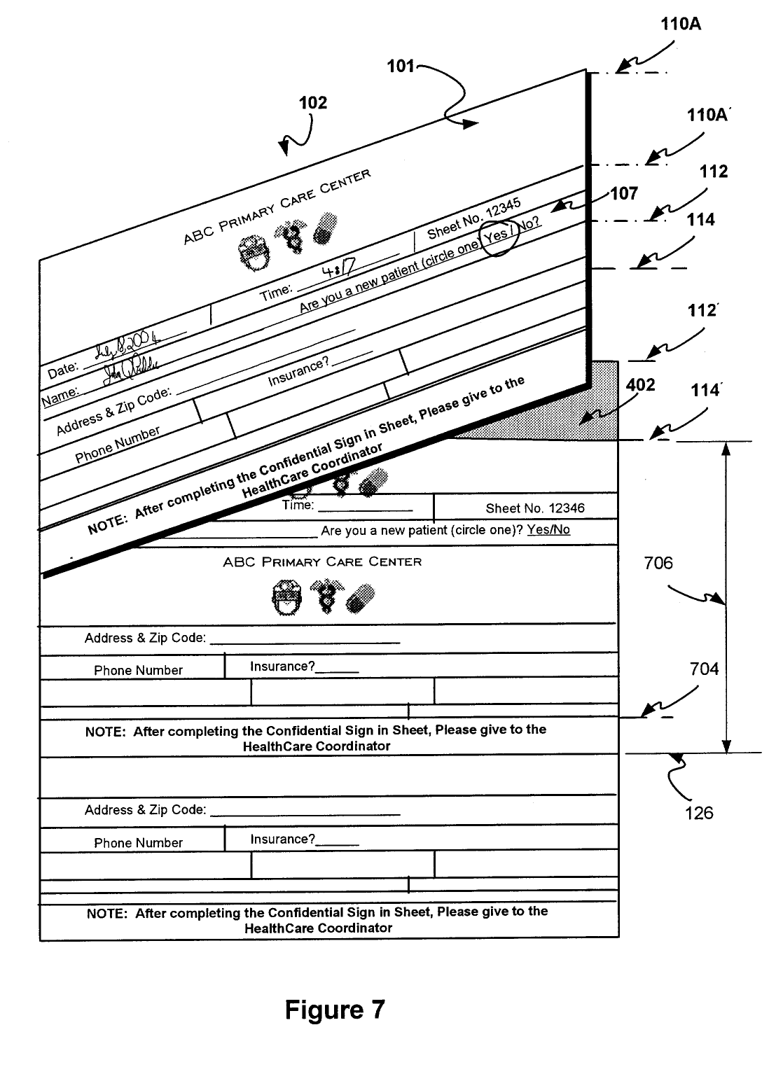

As noted, the plurality of collection sheets are arranged in an overlapping relationship. The overlapping is such that the non-confidential information section of each sheet is in direct communication with media 402. FIG. 7 illustrates an exemplary collection device 102 showing the sheet 101 attached and raised to reveal the reproduction media 402 and the remaining complete patient information sheets intact, and the reproduction media 402. In this position, sheet 101 is illustrative of the positioning of an exemplary collection sheet (e.g., patient information sheet) prior to removal from device 102 upon removal of the topmost collection sheet, a top portion of the media 402 and the remaining collection sheets remain visible as follows: dotted line 112 indicates the topmost edge of the reproduction media 402, and dotted line 126 indicates the location of the bottom edge of the bottommost portion of media 402. Dotted line 114 indicates both the bottom edge of the non-confidential information section 107 and the top edge of the underlying complete patient collection sheet 706. Dotted lines 110A′, 112′, 114′ indicate the relative positions of the top edge of sheet 101, top edge and bottom edge of non-confidential information section 107 prior to sheet 101 being raised. As can be seen, the non-confidential information section 107 directly overlies and contacts media 402, but the remaining portions of sheet 101, which contain the non-confidential information does not. More particularly, only the non-confidential information section of each sheet is in direct contact with media 402 since at least the non-confidential information section of each underlying sheet is positioned between the overlying sheet confidential information section and media 402.

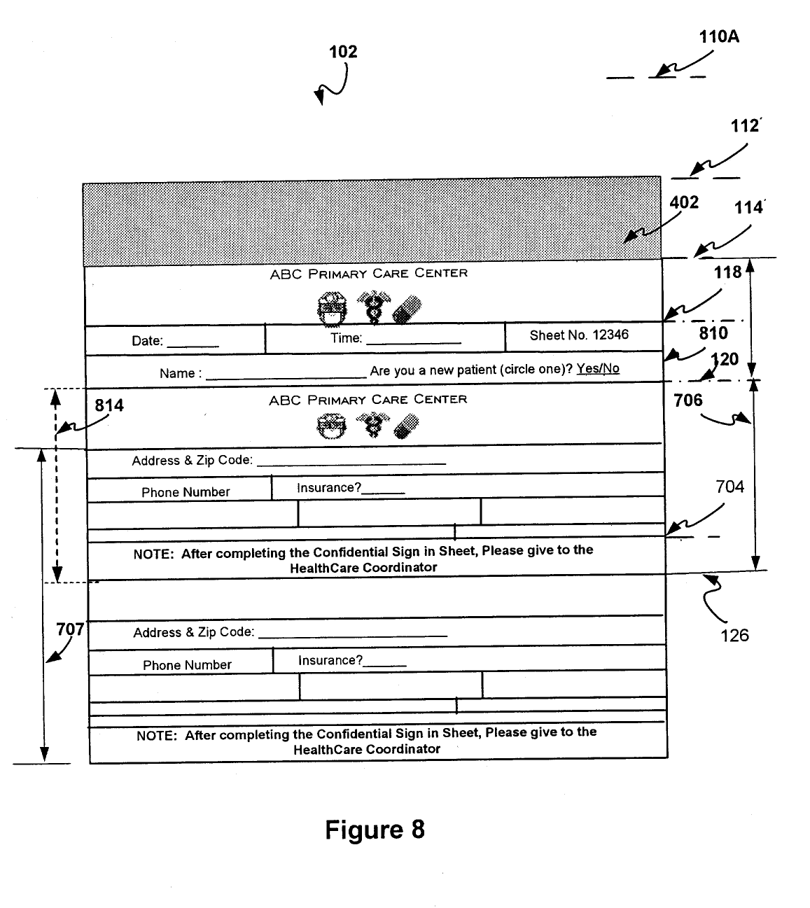

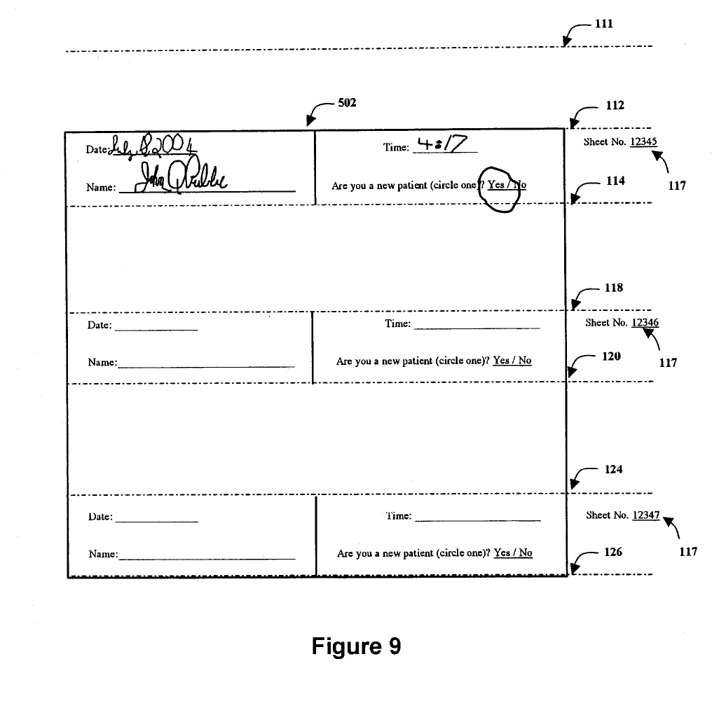

FIG. 8 illustrates the collection device 102 with sheet 101 completely removed. As can be seen, once the sheet 101 is removed, then the first underlying complete patient information sheet 706 is exposed and only a bottom portion of second underlying complete patient information sheet 707 is visible. With respect to sheet 706, dotted line 118 indicates the location of the top edge of non-confidential information section 810 of sheet 706. Dotted 120 indicates the location of the bottom edge of non-confidential information section 810. Thus, the non-confidential information section 810 directly overlies and is in direct communication with media 402. In the preferred embodiment shown, the bottommost portion 814 of sheet 706, which is used to collect the confidential information is not in direct contact with media 402, but instead is in direct contact with the underlying complete patient information sheet 707. That is, the underlying sheets are positioned in between the bottommost portion 814 of the sheet 706. In this arrangement, the impressions made on the topmost sheet 706 (or sheet 101) are substantially transferred to the underlying sheet 706 (or sheet 707), not to media 402. Thus, the confidential information is not reproduced by the media 402 onto record sheet 502.

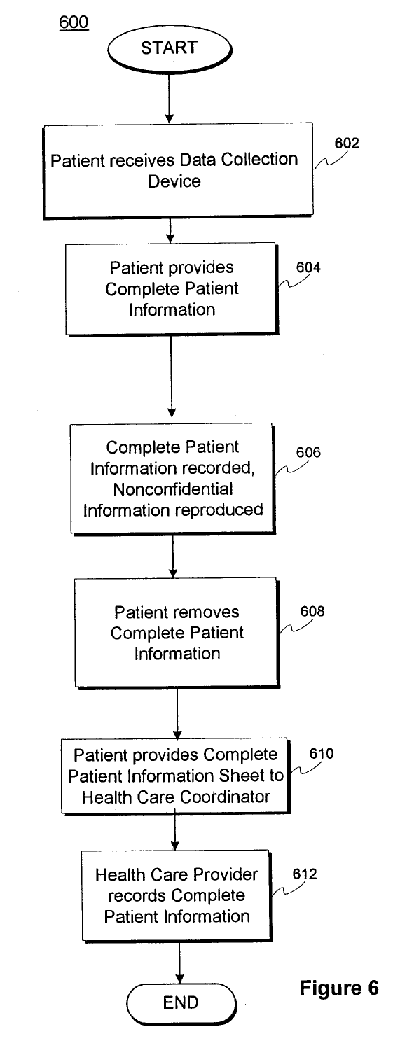

An exemplary operation of the present invention is illustrated with respect to the exemplary flowchart shown in FIG. 6, and with reference to the Figures. To initiate the collection process, a patient may be provided the collection device 102 upon entry into a medical treatment or healthcare facility (step 602). The patient may then provide his complete patient information in accordance with the instructions printed, for example, on sheet 101 (step 604). To facilitate providing the complete patient information, the patient may use a conventional writing instrument, such as, for example, a pencil, pen, marker, crayon etc., illustrated by way of example, by pencil 129 in FIG. 1. That is, the patient would provide, for example, the patient confidential and non-confidential information by writing and recording the information on the sheet 101 in the appropriately marked sections (e.g., confidential information section, non-confidential information section, etc.) (step 606).

The conventional principles of transferring and conveying information via writing, and the operation of pens, pencils, marks, crayons and the like in transferring and recording data are well known. As such, a detailed description of the aforementioned will not be included herein for brevity. Briefly stated, in providing the information, the patient typically must use the pencil 129 to exert a downward pressure on the sheet 101 surface. The pencil 129 may be substantially oblong or irregularly shaped with a first end 131 including a chemical composition for writing. The pencil may be suitably rigid to permit grasping by the human hand and the formation of impressions and indentations in the sheet 101 surface when writing. When used to write, the patient may firmly press the first end 131 onto the sheet 101 front surface creating an impression in any desirable pattern or letter. The chemical composition of pencil 129 may be used to record on the sheet 101 the movement of the pencil 129, while the rigidity of the pencil subjected to appropriate downward force impresses a record of such movement into the sheet 101.

The density and thickness of sheet 101 is such that the impression made by the pencil 129 on the sheet 101 front surface indents the sheet 101 in accordance with the pattern created. Such indentation translates through the body of the sheet 101 and is similarly experienced by media 402. That is, the indentations made on sheet 101 front surfaces are received by media 402 front surface. The thickness of sheet 101 is such that the indentations (e.g., impressions) by media 402 also indent or impress media 402 front surface, thereby translating the impressions through media 402 body.

As noted, the patient provides the complete patient information in the confidential and non-confidential sections of the sheet 101. As is also noted, non-confidential section of sheet 101 is in direct contact with media 402. Thus, the impressions made in the non-confidential section of sheet 101 are transferred to and impressed in media 402. In addition, since reproduction media 402 reproduces the impressions made on its frontside to any surface underlying and contacting the media 402, and since record sheet 502 directly underlies and contacts media 402, then the information provided in the non-confidential section is recorded on the record sheet, as shown in FIG. 9. As shown, the patient has provided, for example, his name in the non-confidential information section of sheet 101. Thus, the patient's name is impressed upon sheet 101 using pencil 129; translated to and received by reproduction media 402, where the name is impressed upon the media 402; and translated to and recorded on record sheet 502. Consequently, FIG. 10 is an exemplary record sheet 502 which includes the patient's non-confidential information recorded from a collection sheet (e.g., sheet 101). Additionally, the patient's non-confidential information may be recorded while being referenced to a unique patient identifier (also called “sheet no.” herein).

The confidential information, on the other hand, is not recorded on the record sheet 502, since the complete patient sheets underlying the confidential information section of the topmost collection sheet interrupts the transfer of the confidential information to the media 402. That is, for example, where three complete patient sheets are stacked in overlapping position, the complete patient sheets are of sufficient thickness such that the thickness of a second underlying sheet prevents the impressions made on an overlying first sheet from being transferred to a third sheet underlying the second sheet. Instead of the media 402 receiving the impressions, the impressions are received by the underlying complete patient information sheet.

Since the non-confidential information is reproduced independently of the confidential information, the non-confidential information may be viewed without regard to confidentiality requirements. That is, an appropriate healthcare provider may view the non-confidential information by referencing record sheet 502. Moreover, the patient non-confidential information is reproduced separately from confidential information in real-time, simultaneously to the information being provided. Particularly, the non-confidential information is produced in real-time as it is being provided by the patient.

Once the complete patient information is provided and anonymized, the patient may then remove the topmost complete patient information sheet from the collection device (e.g., sheet 101) (step 608). The patient may remove the complete patient information sheet 101 by simply tearing, ripping, cutting, detaching, ungluing or any method suitable for removing the sheet 101 as required by the means in which the sheet 101 is attached to the device 102. Once removed, the patient may provide the completed patient information sheet 101 to a healthcare coordinator or other personnel for recording the information (step 610). The healthcare coordinator may then enter the complete patient information into a computer system 104 for use in storing and correlating the patient data (step 610). The complete patient information may be stored on database 106 correlative to the unique patient identifier for later reference and/or retrieval using commands provided by processor 108.

As can be seen with respect to FIG. 9, the non-confidential information is recorded on the record sheet 502 during the information collection process. As noted, each complete patient sheet is provided with a unique sheet number (e.g., sheet number 117 in FIG. 2). As is noted, the non-confidential information is recorded on the record sheet with respect to the unique sheet number. Thus, the particular patient non-confidential information recorded in this manner may be stored correlated to the sheet number 117 appearing adjacent the non-confidential information.

For example, when providing the complete patient information to computer system 104, the healthcare provider correlates the appropriate sheet number 117 corresponding to the complete patient information sheet to the complete patient information. The complete patient information may be stored on database 106 in any suitable manner permitting the sheet number 117 to be matched with the patient information entered into system 104, by a processor 108. With the information stored in this manner, the healthcare provider may later retrieve the patient information by, for example, using any suitable application permitting the healthcare provider to provide at least the sheet number to system 104 and retrieve the correlative patient information from database 106. It should be noted, that both the confidential and non-confidential information is stored on database 106. Thus, a suitable application may permit the healthcare provider to retrieve all or portions of both the confidential and non-confidential information with respect to the sheet number 117, as required.

Since only the non-confidential information section is in direct communication with media 402, only the impressions made in the non-confidential section will be reproduced on the record sheet 502. FIG. 10 illustrates a record sheet 502 showing exemplary reproductions of impressions made in the non-confidential information section 107 and transferred by media 402. Record sheet 502 is of sufficient rigidity to receive the reproduction of the impressions made on the non-confidential information section 107. To aid in the transfer, record sheet 502 and/or device 102 may be placed on a rigid surface such that the impressions made on the complete patient information sheet may be enhanced. In one exemplary embodiment, the collection device 102 may include a rear support (not shown) which may be of substantially similar size and shape as the device 102. Alternatively, the support may be irregularly shaped. The support may be of sufficient rigidity to aid it enhancing the quality of the impressions made by providing a rigid surface on which to write.

As can be seen, the present invention fulfills the needs of the prior art by providing a system and method for collecting complete patient information which permits the non-confidential information to be reproduced separately from the confidential information. The invention is cost-effective in that portions of the invention (e.g., data collection sheets, record sheets) may be constructed of conventional readily available paper. Further, the present invention provides a system and method to reproduce in a single location and in real-time, non-confidential information while additionally, separately recording both the confidential and non-confidential information. In this way, the invention permits the healthcare provider to prescreen a patient, thereby speeding up the treatment experience. It should be noted, that although the present invention is described with respect to confidential and non-confidential information, this nomenclature is used illustratively. In fact, the present invention is useful for any operation requiring one portion of written or typed data to be separated from another.

The preceding detailed description of exemplary embodiments of the invention makes reference to the accompanying drawings, which show the exemplary embodiment by way of illustration. While these exemplary embodiments are described in sufficient detail to enable those skilled in the art to practice the invention, it should be understood that other embodiments may be realized and that logical and mechanical changes may be made without departing from the spirit and scope of the invention. Thus, the preceding detailed description is presented for purposes of illustration only and not of limitation, and the scope of the invention is defined solely by the appended claims and their legal equivalents when properly read in light of the preceding description. For example, the steps recited in any of the method or process claims may be executed in any order and are not limited to the order presented.

1. A system for selective collection of information comprising:
a first complete information collection sheet, including a first portion for collection of a first information and a second portion for collection of a second information, said first portion including a first select information section;
a second complete information collection sheet underlying said first complete information collection sheet in overlapping position, wherein a top edge of said second complete information collection sheet is substantially aligned with a bottom edge of said first select information collection section of said first complete information collection sheet, said second complete information collection sheet including a third portion for collection of a third information and a fourth portion for collection of a fourth information, said third portion including a second select information section;
a reproduction enabling media underlying said first and second complete information collection sheets, said reproduction enabling media in direct communication with said first and second select information section; and
a record data sheet underlying said enabling media, said record data sheet in communication with said reproduction enabling media.

2. The system of claim 1, wherein said first and second complete collection information sheets are individually removable with the first complete information collection sheet removable prior to the second complete collection information sheet being removable.

3. A system of claim 1, wherein said first and second complete information collection sheets, said reproduction enabling media and said record data sheet are detachably affixed one to another.

4. A system of claim 1, wherein said first and second complete information collection sheets include instructions for providing information, said first portion including instructions for providing said first select information and said second portion including instructions for providing said second information, said third portion including instructions for providing said second select information and said fourth portion including instructions for providing said fourth information.

5. A system of claim 4, wherein information provided to said first select information section is provided to said reproduction enabling media and information provided to said second portion is provided to said second complete information collection sheet.

6. A system of claim 5, wherein information provided to said second select information section is provided to said reproduction enabling media and information provided to said fourth portion is provided to said second complete information collection sheet.

7. A system of claim 6, wherein said first complete information collection sheet is detached prior to providing the information to the second select information section.

8. The system of claim 5, wherein said first select information section information is provided from said reproduction enabling media to said record data sheet in real-time.

9. The system of claim 8, wherein said first select information section information is provided to said reproduction enabling media in real-time.

10. The system of claim 8, wherein first select information section information is recorded on said record data sheet relative to a unique first information identifier.

11. The system of claim 7, wherein the second select information section information is provided from said reproduction enabling media to said record data sheet in real-time.

12. The system of claim 11, wherein second select information section information is recorded on said record data sheet relative to a unique second information identifier.

13. A system for selective collection of information comprising:
a plurality of complete information collection sheets stacked in overlapping manner, wherein each one of said plurality of complete information sheets includes a first portion for collection of select information and a second portion for collection of nonselective information;
a reproduction enabling media underlying said plurality of complete information collection sheets, said reproduction enabling media in contact with said first portion of each one of said plurality of complete information collection sheets; and
a record data sheet underlying said reproduction enabling media, said plurality of complete information collection sheets positioned such that a top edge of each underlying one of said plurality of complete information collection sheets is substantially aligned with the bottom edge of the first portion of the next preceding overlying one of said plurality of complete information collection sheets, said plurality of complete collection sheets, reproduction enabling media and record data sheets being immovably positioned one to the other.

14. The system of claim 13, wherein each one of the plurality of complete information collection sheets is individually detachable from the remaining sheets.

15. The system of claim 14, wherein said first portion includes instructions for providing information to said first portion, said information provided to said first portion is provided to said reproduction enabling media.

16. The system of claim 15, wherein said information provided to said reproduction enabling media is reproduced on said record data sheet.

17. A method for select collection of information, comprising:
using one of a plurality of complete information sheets to provide information, the plurality of complete information collection sheets being arranged in overlapping manner such that topmost sheet is obscuring a first portion of the next successive underlying sheet the plurality of sheets further arranged such that a portion of each sheet is in contact with a reproduction enabling media for reproducing the information provided to the portion of each sheet in contact with the media;
reproducing on a record data sheet in real-time information provided to the portion of each plurality of complete information collection sheets; and
removing a topmost one of the plurality of complete collection sheets to provide information to the next successive underlying sheet.

18. A method for select collection of information, comprising:
arranging a plurality of sheets in an overlapping manner such that the topmost sheet is obscuring a first portion of the next successive underlying sheet of the plurality of sheets;
arranging the plurality of sheets such that a portion of each sheet is in contact with a reproduction enabling media for reproducing the information provided to the portion of each sheet in contact with the media; and
enabling the reproduction in real-time on a record data sheet information provided to the portion of each plurality of complete information collection sheets.
